(19) United States
(12) Patent Application Publication
(10) Pub. No.: US 2003/0002295 A1
(43) Pub. Date: Jan. 2, 2003

(54) Apparatus and method for displaying a luminescent icon

(76) Inventor: Gian-Paolo Musumeci, San Francisco, CA (US)

Correspondence Address: WILLIAMS MORGAN & AMERSON, 7676 HILLMONT, SUITE 250, HOUSTON, TX, 77040, US

(21) Appl. No.: 09/894,952

(22) Filed: Jun. 28, 2001

(51) Int. Cl. F21V 8/00; G09F 13/00

(52) U.S. Cl. 362/559; 362/554; 362/800; 40/547; 40/444

(57) ABSTRACT

An apparatus capable of displaying a luminescent icon includes a light source and a light pipe capable of allowing light to propagate therethrough. The light pipe has a first end capable of receiving light from the light source and a second end capable of emitting the light from the light source, wherein the second end has a shape corresponding to the luminescent icon. A method capable of displaying a luminescent icon includes emitting a light from a light source and forming the light into a shape corresponding to the luminescent icon.

### BACKGROUND OF THE INVENTION

1. Field of the Invention

This invention relates to an apparatus and method for displaying a luminescent icon, and, in one aspect, to an apparatus and method for displaying a luminescent icon on a computer system component.

2. Description of the Related Art

Computer system modules are often interconnected with other components or peripherals to enhance their usefulness. For example, a primary computer system module, often referred to as a CPU, can be interconnected with a printer, an external storage media drive, another computer system module, or the like. Such interconnections are often accomplished by connecting one end of a cable to a connector on one component and connecting the other end of the cable to a connector on another component. The cable and connectors typically comprise multiple conductors, i.e., they provide interconnections for more than one signal line. Generally the signal lines are for transmitting electrical signals, optical signals, or the like. For example, one type of small computer system interface (SCSI) uses at least 25-conductor connectors and cabling to interconnect components. Interconnections can also be accomplished by interconnecting connectors of desired components to a network, e.g., an Ethernet network, thus interconnecting the desired components with each other.

In any case, component connectors are typically found on a rear panel of the component and are marked by various icons that are often molded into the panel as raised and/or indented markings. Different icons are used to distinguish between the various interfaces. For example, a component may have a SCSI interface, a parallel interface, and an Ethernet interface, just to name a few. Each interface connector may have a corresponding icon (or other marking, such as wording) to indicate the type of interface. These icons or other markings are often difficult to discern, due to their size, lack of contrast with the surrounding panel, or color of the icon and panel. Further, as can be appreciated by those skilled in the art, these types of interconnections are at times made in less than ideal lighting, as the components are often in cabinets, racks, or other enclosures. Thus, it may be very difficult to determine which connectors are to be interconnected.

Other difficulties can arise as different interfaces may have common types of connectors. For example, a SCSI interface may employ a Centronics™-type connector, which is also a common parallel interface connector. Further, a serial interface may use a DB25-type D-shell connector, while some SCSI interfaces use the same connector. Interconnecting different interfaces (e.g., interconnecting a parallel interface with a SCSI interface) results in a non-operative interconnection and may, in certain instances, damage one or more components being interconnected. At very least, misconnected interfaces can result in lost time and, if damage to one or more components results, can result in significant asset losses.

While interconnecting and troubleshooting various interfaces, it can be desirable to know whether the interface is interconnected and working properly. Often the operating condition of the interface is determined via software utilities executed on, for example, the primary computer module or by attempting to access one or more of the components via the primary computer module. Making the necessary connections, often at the rear of the components being interconnected, then running these utilities can be cumbersome and time consuming. In many instances, it would be beneficial to determine the condition of an interface, after making the connections, without leaving the rear of the component.

### SUMMARY OF THE INVENTION

An apparatus capable of displaying a luminescent icon includes a light source and a light pipe capable of allowing light to propagate therethrough. The light pipe has a first end capable of receiving light from the light source and a second end capable of emitting the light from the light source, wherein the second end has a shape corresponding to the luminescent icon.

A method capable of displaying a luminescent icon includes emitting a light from a light source and forming the light into a shape corresponding to the luminescent icon.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is a stylized rear view of a computer system component;

FIG. 2 is a perspective view of a formed light pipe embodiment of the present invention and further illustrating light-emitting diodes capable of emitting light into the light pipe;

FIG. 3 is a front view of a apparatus according to the present invention utilizing the formed light pipe of FIG. 2;

FIG. 4 is a cross-sectional view of the apparatus of FIG. 3 taken along the IV-IV line;

FIG. 5 is a front view of an apparatus according to the present invention;

FIG. 6 is a cross-sectional view of the apparatus of FIG. 5 taken along the VI-VI line;

FIG. 7 is a front view of an apparatus according to the present invention;

FIG. 8 is a cross-sectional view of the apparatus of FIG. 7 taken along the VIII-VIII line;

FIG. 9 is a front view of an apparatus according to the present invention;

FIG. 10 is a cross-sectional view of the apparatus of FIG. 9 taken along the X-X line;

FIG. 11 is a front view of an apparatus according to the present invention;

FIG. 12 is a cross-sectional view of the apparatus of FIG. 11 taken along the XII-XII line;

FIG. 13 is a front view of a faceplate according to the present invention; and

FIG. 14 is a cross-sectional view of the faceplate of FIG. 13 taken along the XIV-XIV line.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

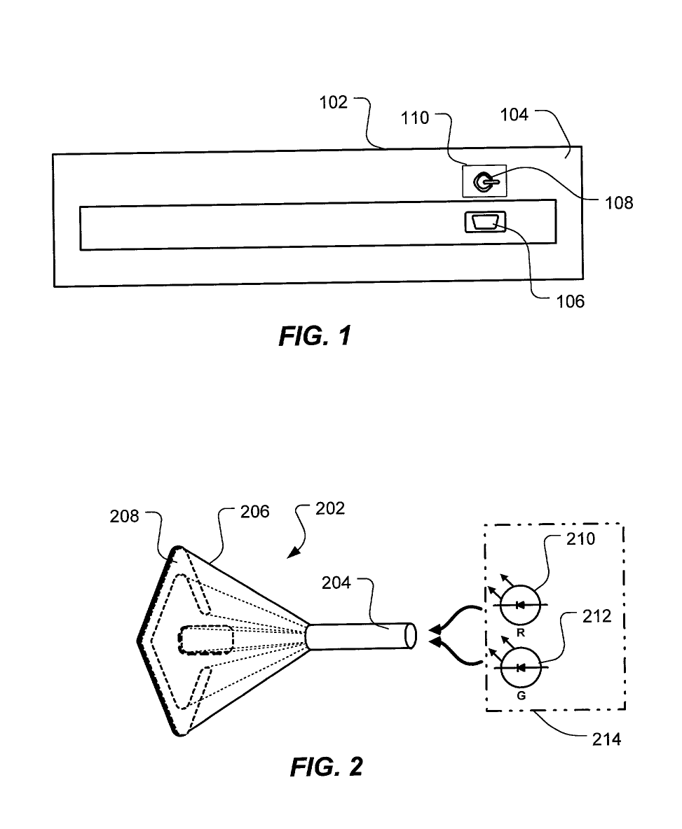

According to the illustrated embodiment of FIG. 1, a computer system component 102 (e.g., a primary computer system module, a printer, an external storage media drive, or the like) has one or more connectors 106 (only one illustrated) on a rear panel 104 for interconnecting the computer system component 102 with another component (not shown). Such interconnections are often accomplished by attaching one end of a multi-conductor electrical cable (not shown) to the connector 106 and attaching the other end of the multi-conductor cable to an electrical connector on the other component. While the connector 106 is illustrated to be a D-shell connector, any type of connector (e.g., D-shell, Centronics™, DIN, RJ-type, or the like) is within the scope of the present invention. A luminescent icon 108 is provided, corresponding to the connector 106, to identify the type of interface associated with the connector 106. The luminescent icon 108 gives off its own light or glows when in an active state. While, in the illustrated case, the luminescent icon 108 identifies the connector 106 as providing a connection to a SCSI interface, the form of the luminescent icon 108 represents whatever type of interface the connector 106 happens to be. For example, if the connector 106 provides a connection to a parallel printer interface, the luminescent icon 108 corresponds to a symbol representing the parallel printer interface; if the connector 106 provides a connection to an Ethernet interface, the form of the luminescent icon 108 is chosen to represent the Ethernet interface. The luminescent icon 108 can be an integral part of the rear panel 104 or a faceplate 110 that is inserted into the rear panel 104. Further, the luminescent icon 108 can be part of, attached to, integrated with, or adjacent any portion of the computer system component 102

Referring now to FIG. 2, an embodiment of the present invention provides a light pipe 202 having a body portion 204 and a formed portion 206. The formed portion 206 transitions from a cross-sectional shape of the body portion 204 to a cross-sectional shape of the luminescent icon 108 at an end 208. Thus, in the illustrated example, the formed portion 206 transitions from a round cross-section (the shape of the body portion 204) to a shape of a SCSI icon (the shape of the end 208). In the illustrated embodiment, a red light-emitting diode (LED) 210 and a green LED 212 comprise a light source 214 capable of emitting light that propagates through the body portion 204 and the formed portion 206 of the light pipe 202 and is emitted at the end 208. Thus, in a certain situation, a direct current is passed through the red LED 210 and no current is passed through the green LED 212 so that a red light is emitted from the end 208. In another situation, a direct current is passed through the green LED 212 and no current is passed through the red LED 210 so that a green light is emitted from the end 208. In yet another situation, an alternating current, (e.g., a 60-Hz alternating current) is passed through each of the red LED 210 and the green LED 212 so that a yellow light is emitted from the end 208. Since the LEDs 210, 212 are diodes, which allow current to pass only in one direction, applying the alternating current to the LEDs 210, 212 causes the LEDs 210, 212 to blink. If a sufficiently high-frequency alternating current is used to drive the LEDs 210, 212, the LEDs 210, 212 blink at a rate faster than can be detected by a human eye. Thus, a yellow light appears to be emitted from the end 208.

In one embodiment of the present invention, a yellow light (or light that appears to be yellow to the human eye) is emitted from the light source 214 (and thus the end 208) if no component is interconnected with the interface corresponding to the luminescent icon 108. Further, a green light is emitted from the light source 214 (and thus the end 208) if a component is interconnected with the interface corresponding to the luminescent icon 108 and the interface is operating correctly. Yet further, a red light is emitted from the light source 214 (and thus the end 208) if a component is interconnected with the interface corresponding to the luminescent icon 108 and the interface is not operating properly. While this color scheme has been described, the present invention encompasses any desired color scheme for light emitted from the light source 214 and the end 208.

While two LEDs 210, 212 are illustrated in FIG. 2, they may be packaged in one molding as one two-color LED. Further, the scope of the present invention encompasses any light source 214 capable of emitting light into the light pipe 202, for example, an incandescent lamp, a florescent lamp, a neon lamp, or the like.

Light pipes (such as light pipe 202) are typically made of a transparent material (e.g., silica, polycarbonate, or the like) that usually is drawn into a cylindrical, pyramidical, conical, or other shape through which light is channeled from one end to the other generally by internal reflections. Optical fibers, which are examples of light pipes, are thin filaments of drawn or extruded glass or plastic having a central core and a cladding of a material that promotes internal reflection. Optical fibers may be used singly or in bundles to transmit light or images. Accordingly, the light pipe 202 can be any suitable variety of light pipe, optical fiber, or bundle of optical fibers.

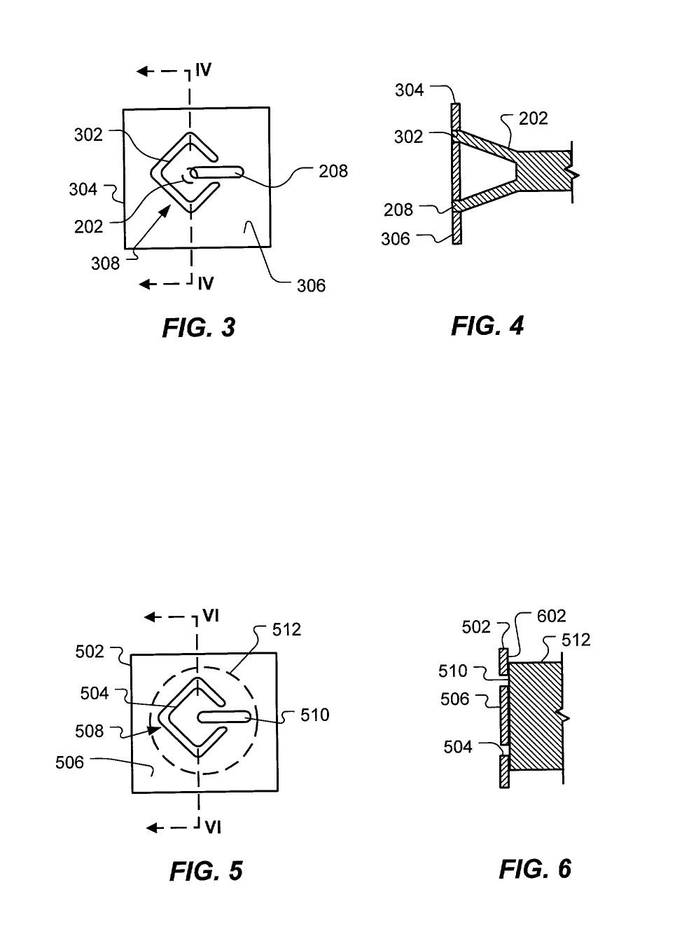

Referring now to FIGS. 3 and 4, the illustrated embodiment provides the end 208 of the light pipe 202 inserted into a shaped cutout 302 in a panel 304. The panel 304 can be any desired panel, for example the rear panel 104, the faceplate 110, or the like. The end 208 can be disposed within the shaped cutout 302, adhesively attached within the shaped cutout 302, or the panel 304 can be molded around the end 208. While the light pipe 202 is illustrated in FIGS. 2-4 as having a round cross-sectional shape, the light pipe 202 may be of any shape as required to fit the application. Thus, by viewing the outside surface 306 of the panel 304 while light is being emitted from the end 208 of the light pipe 202, a luminescent icon 308 is appreciated.

In another embodiment, as illustrated in FIGS. 5 and 6, a panel 502 is provided having a shaped cutout 504. An end 510 of a light pipe 512 is disposed adjacent the inside surface 602 of the panel 502 and generally covering the shaped cutout 504. Light is emitted from a light source (not shown), propagates through the light pipe 512, and is emitted from the end 510. The shaped cutout 504 allows the light to pass therethough, while the panel 502 masks the light and prevents it from propagating beyond the inside surface 602 of the panel 502. Thus, by viewing the outside surface 506 of the panel 502 while light is being emitted from the end 510 of the light pipe 512, a luminescent icon 508 is appreciated.

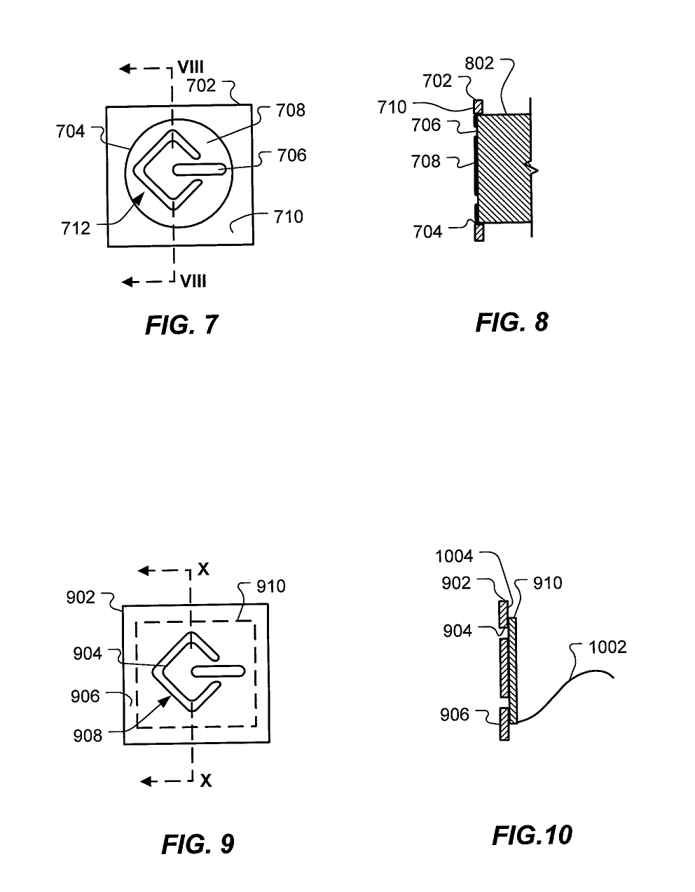

It is within the scope of the present invention for the end 510 to be a different dimension or cross-sectional shape than another portion or portions of the light pipe 512. Further, in the embodiment illustrated in FIGS. 7 and 8, a panel 702 has an opening 704 sized to accept an end 706 of a light pipe 802. Instead of the panel 702 acting as a mask (as illustrated in FIGS. 5 and 6), a mask 708 is provided to prevent light from propagating from desired areas of the end 706 of the light pipe 802. Thus, by viewing the outside surface 710 of the panel 702 while light is being emitted from the end 706 of the light pipe 802, a luminescent icon 712 is appreciated.

Referring now to FIGS. 9 and 10, the illustrated embodiment provides a panel 902 having a shaped cutout 904. An electroluminescent panel 910 is disposed adjacent an inside surface 1004 of the panel 902 and generally covering the shaped cutout 904. One example of the electroluminescent panel 910 is a sandwich-like device in which a phosphorescent layer is disposed between two electrodes. The phosphorescent layer emits light when a current is passed between the electrodes via wiring 1002. In the illustrated embodiment, the shaped cutout 904 allows portions of the light, emitted from the electroluminescent panel 910, to pass therethough, while the panel 902 masks a portion of the light emitted from the electroluminescent panel 910 and prevents it from propagating beyond the inside surface 1004 of the panel 902. Thus, by viewing an outside surface 906 of the panel 902 while light is being emitted from the electroluminescent panel 910, a luminescent icon 908 is appreciated.

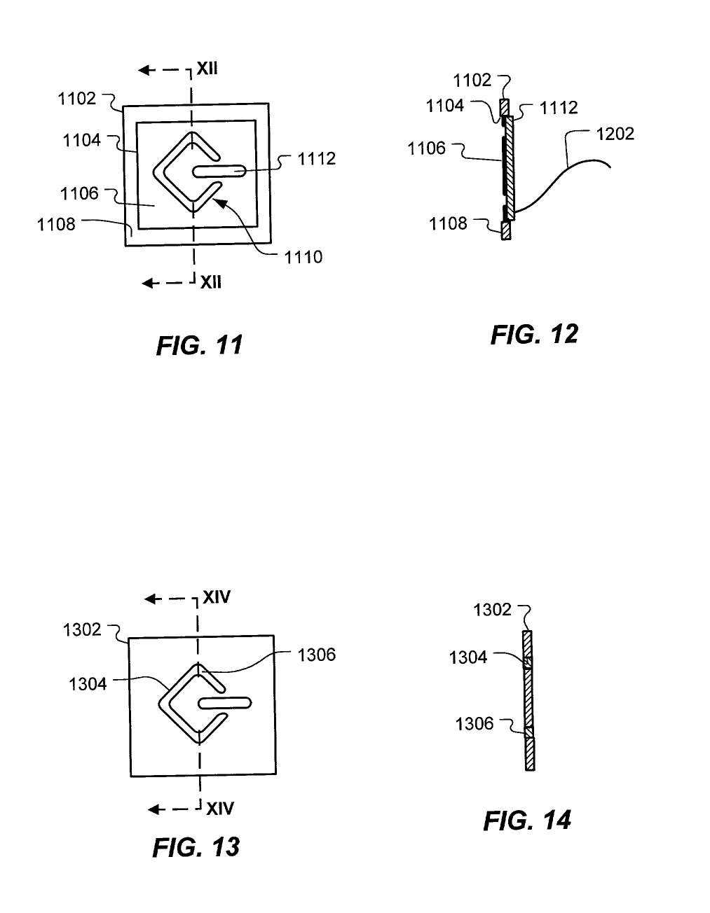

Similar to the embodiment illustrated in FIGS. 7 and 8, the embodiment illustrated in FIGS. 11 and 12 provides a panel 1102 that has an opening 1104 sized to accept an electroluminescent panel 1112. Instead of the panel 1102 acting as a mask (as illustrated in FIGS. 9 and 10), a mask 1106 is provided to prevent light from propagating from desired areas of the electroluminescent panel 1112. The electroluminescent panel 1112 is powered via wiring 1202. Thus, by viewing an outside surface 1108 of the panel 1102 while light is being emitted from the electroluminescent panel 1112, a luminescent icon 1110 is appreciated.

Referring now to FIGS. 13 and 14, a faceplate 1302 is provided having a shaped cutout 1304, as in previous embodiments. The shaped cutout 1304 is generally filled with a translucent material 1306, which seals off the faceplate 1302 while allowing light to pass through the shaped cutout 1304. A translucent material, such as the translucent material 1306, may also generally fill the cutouts 704, 1104 and/or open spaces in the masks 708, 1106.

A method according to the present invention includes emitting a light from a light source and forming the light into a shape corresponding to a luminescent icon. In one embodiment, light is emitted from the light source if a predetermined condition exists (e.g., power is applied to the system, etc.) In another embodiment, light is emitted from the light source having a color corresponding to a predetermined condition. In one situation, the method includes emitting a yellow light from the light source if a component is not interconnected with the interface corresponding to the luminescent icon. A green light is emitted from the light source if the component is interconnected with the interface corresponding to the luminescent icon and the interface is operating properly. A red light is emitted from the light source if the component is interconnected with the interface corresponding to the luminescent icon and the interface is not operating properly. In one embodiment, proper operation of a computer system component is determined based upon a color of light emitted from the luminescent icon.

In another method according to the present invention, light is emitted from the light source and a portion of the light is masked to prevent the masked portion of light from propagating. An unmasked portion of the light corresponds to the shape of the luminescent icon.

The present invention further encompasses an apparatus having means for performing certain embodiments of the method of the invention described herein and their equivalents.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, in the sense of Georg Cantor. Accordingly, the protection sought herein is as set forth in the claims below.

What is claimed:

1. An apparatus capable of displaying a luminescent icon, comprising:
a light source; and
a light pipe capable of allowing light to propagate therethrough, the light pipe having a first end capable of receiving light from the light source and a second end capable of emitting the light from the light source, wherein the second end has a shape corresponding to the luminescent icon.

2. An apparatus, according to claim 1, wherein the light source comprises at least one light-emitting diode.

3. An apparatus, according to claim 2, wherein the at least one light-emitting diode comprises a two-color light emitting diode.

4. An apparatus, according to claim 3, further comprising a power source capable of providing a direct current and an alternating current to the two-color light emitting diode.

5. An apparatus, according to claim 1, wherein the light source comprises a lamp selected from the group consisting of an incandescent lamp, a fluorescent lamp, and a neon lamp.

6. An apparatus, according to claim 1, wherein the light source is capable of emitting light of various colors.

7. An apparatus, according to claim 1, wherein the light pipe comprises a single light conductor and wherein the light pipe further comprises a formed portion in which a cross-sectional shape of the light pipe transitions from a first shape to the shape corresponding to the luminescent icon.

8. An apparatus, according to claim 1, wherein the light pipe comprises a bundle of optical fibers and the bundle of optical fibers is divided into a plurality of bundles of optical fibers to form the luminescent icon.

9. An apparatus, according to claim 1, further comprising a panel having a cutout, the cutout having a shape corresponding to the shape of the second end of the light pipe, wherein the second end of the light pipe is disposed in the cutout.

10. An apparatus, according to claim 1, further comprising a panel, wherein the panel is molded around the second end of the light pipe.

11. An apparatus for displaying a luminescent icon, comprising:
a panel having a cutout corresponding to a shape of the luminescent icon, the panel having an inside surface;
a light source; and
a light pipe capable of propagating light therethrough, the light pipe having a first end capable of receiving light from the light source and a second end capable of emitting the light from the light source,
wherein the second end is disposed adjacent the inside surface of the panel and generally covers the cutout.

12. An apparatus, according to claim 11, wherein the light source comprises at least one light-emitting diode.

13. An apparatus, according to claim 12, wherein the at least one light-emitting diode comprises a two-color light emitting diode.

14. An apparatus, according to claim 13, further comprising a power source capable of providing a direct current and an alternating current to the two-color light emitting diode.

15. An apparatus, according to claim 11, wherein the light source comprises a lamp selected from the group consisting of an incandescent lamp, a fluorescent lamp, and a neon lamp.

16. An apparatus, according to claim 11, wherein the light source is capable of emitting light of various colors.

17. An apparatus, according to claim 11, wherein the light pipe comprises a single light conductor.

18. An apparatus, according to claim 11, wherein the light pipe comprises a bundle of optical fibers.

19. An apparatus, according to claim 11, further comprising a translucent material generally filling the cutout.

20. An apparatus for displaying a luminescent icon, comprising:
a panel having an opening and an inside surface;
a light source;
a light pipe capable of allowing light to propagate therethrough, the light pipe having a first end capable of receiving light from the light source and a second end capable of emitting the light from the light source;
a mask having open portions corresponding to a shape of the luminescent icon, wherein the mask covers a portion of the second end of the light pipe to restrict light from propagating beyond the mask except through the open portions of the mask,
wherein the opening is sized to accept the second end of the light pipe and the second end of the light pipe is disposed within the opening.

21. An apparatus, according to claim 20, wherein the light source comprises at least one light-emitting diode.

22. An apparatus, according to claim 21, wherein the at least one light-emitting diode comprises a two-color light emitting diode.

23. An apparatus, according to claim 22, further comprising a power source capable of providing a direct current and an alternating current to the two-color light emitting diode.

24. An apparatus, according to claim 20, wherein the light source comprises a lamp selected from the group consisting of an incandescent lamp, a fluorescent lamp, and a neon lamp.

25. An apparatus, according to claim 20, wherein the light source is capable of emitting light of various colors.

26. An apparatus, according to claim 20, wherein the light pipe comprises a single light conductor.

27. An apparatus, according to claim 20, wherein the light pipe comprises a bundle of optical fibers.

28. An apparatus, according to claim 20, further comprising a translucent material generally filling the cutout.

29. An apparatus for displaying a luminescent icon, comprising:
a panel having a cutout corresponding to a shape of the luminescent icon, the panel having an inside surface; and
a light source disposed adjacent the inside surface and generally covering the cutout.

30. An apparatus, according to claim 29, wherein the light source comprises an electroluminescent panel.

31. An apparatus, according to claim 29, further comprising a translucent material generally filling the cutout.

32. An apparatus capable of displaying a luminescent icon, comprising:
a panel having an opening;
a light source; and
a mask having open portions corresponding to a shape of the luminescent icon, wherein the mask covers a portion of the light source to restrict light from propagating beyond the mask except through the open portions of the mask,
wherein the opening is sized to accept the light source and the light source is disposed within the opening.

33. An apparatus, according to claim 32, wherein the light source comprises an electroluminescent panel.

34. An apparatus, according to claim 32, further comprising a translucent material generally filling the opening.

35. A computer system component, comprising:
an enclosure having a panel, the panel having a cutout corresponding to a shape of a luminescent icon, the panel having an inside surface; and
a light source disposed inside the enclosure such that light emitted from the light source is propagated through the cutout.

36. A computer system component, according to claim 35, wherein the light source comprises an electroluminescent panel.

37. A computer system component, according to claim 35, further comprising a translucent material generally filling the cutout.

38. A computer system component, according to claim 35, further comprising a light pipe disposed between the light source and the inside surface of the panel such that light emitted from the light source is capable of propagating through the light pipe before propagating through the cutout.

39. A computer system component, according to claim 35, wherein the light source comprises at least one light-emitting diode.

40. A computer system component, according to claim 39, wherein the at least one light-emitting diode comprises a two-color light emitting diode.

41. A computer system component, according to claim 35, wherein the light source comprises a lamp selected from the group consisting of an incandescent lamp, a fluorescent lamp, and a neon lamp.

42. A computer system component, according to claim 35, wherein the light source is capable of emitting light of various colors.

43. A computer system component, according to claim 38, wherein:
the light pipe comprises a single light conductor;
the light pipe has a first end capable of receiving light from the light source and a second end capable of emitting the light from the light source;
the second end has a shape corresponding to the luminescent icon; and
the light pipe further comprises a formed portion in which a cross-sectional shape of
the light pipe transitions from a first shape to the shape corresponding to the luminescent icon.

44. A computer system component, according to claim 43, wherein the second end of the light pipe is disposed in the cutout.

45. A computer system component, according to claim 38, wherein:
the light pipe comprises a bundle of optical fibers;
the light pipe having a first end capable of receiving light from the light source and a second end capable of emitting the light from the light source;
the second end has a shape corresponding to the luminescent icon; and
the bundle of optical fibers is divided into separate optical fibers to form the luminescent icon.

46. A computer system component, according to claim 43, wherein the second end of the light pipe is disposed in the cutout.

47. A computer system component, according to claim 38, further comprising a panel, wherein the panel is molded around the second end of the light pipe.

48. A computer system component, comprising:
an enclosure having a panel, the panel having a cutout;
a light source disposed within the enclosure; and
a mask having open portions corresponding to a shape of the luminescent icon, wherein the mask covers a portion of the cutout to restrict light from propagating beyond the mask except through the open portions of the mask.

49. A computer system component; according to claim 48, wherein the light source comprises an electroluminescent panel.

50. A computer system component, according to claim 48, further comprising a translucent material generally filling the cutout.

51. A computer system component, according to claim 48, wherein the panel has an inside surface, the computer system component further comprising a light pipe disposed between the light source and the inside surface of the panel such that light emitted from the light source is capable of propagating through the light pipe before propagating through the cutout.

52. A computer system component, according to claim 48, wherein the light source comprises at least one light-emitting diode.

53. A computer system component, according to claim 52, wherein the at least one light-emitting diode comprises a two-color light emitting diode.

54. A computer system component, according to claim 48, wherein the light source comprises a lamp selected from the group consisting of an incandescent lamp, a fluorescent lamp, and a neon lamp.

55. A computer system component, according to claim 48, wherein the light source is capable of emitting light of various colors.

56. A method capable of displaying a luminescent icon, comprising:
emitting a light from a light source; and
forming the light into a shape corresponding to the luminescent icon.

57. A method, according to claim 56, wherein emitting the light from the light source further comprises emitting the light from the light source if a predetermined condition exists.

58. A method, according to claim 57, wherein emitting the light from the light source further comprises emitting the light from the light source having a color corresponding to the predetermined condition.

59. A method, according to claim 56, wherein emitting the light from the light source further comprises:
emitting a yellow light from the light source if a component is not interconnected with an interface corresponding to the luminescent icon;
emitting a green light from the light source if the component is interconnected with the interface corresponding to the luminescent icon and the interface is operating properly; and
emitting a red light from the light source if the component is interconnected with the interface corresponding to the luminescent icon and the interface is not operating properly.

60. A method, according to claim 57, further comprising determining a condition of a computer system component based upon a color of light emitted from the luminescent icon.

61. A method capable of displaying a luminescent icon, comprising:
emitting light from a light source;
masking a portion of the light to prevent the masked portion of the light from propagating, wherein an unmasked portion of the light corresponds to a shape of the luminescent icon.

62. A method, according to claim 61, wherein emitting the light from the light source further comprises emitting the light from the light source if a predetermined condition exists.

63. A method, according to claim 61, wherein emitting the light from the light source further comprises emitting the light from the light source having a color corresponding to a predetermined condition.

64. A method, according to claim 61, wherein emitting the light from the light source further comprises:
emitting a yellow light from the light source if a component is not interconnected with an interface corresponding to the luminescent icon;
emitting a green light from the light source if the component is interconnected with the interface corresponding to the luminescent icon and the interface is operating properly; and
emitting a red light from the light source if the component is interconnected with the interface corresponding to the luminescent icon and the interface is not operating properly.

65. A method, according to claim 62, further comprising determining a condition of a computer system component based upon a color of light emitted from the luminescent icon.

66. An apparatus capable of displaying a luminescent icon, comprising:
means for emitting a light from a light source; and
means for forming the light into a shape corresponding to the luminescent icon.

67. An apparatus, according to claim 66, wherein the means for emitting the light from the light source further comprises means for emitting the light from the light source if a predetermined condition exists.

68. An apparatus, according to claim 67, wherein the means for emitting the light from the light source further comprises means for emitting the light from the light source having a color corresponding to a predetermined condition.

69. An apparatus, according to claim 66, wherein the means for emitting the light from the light source further comprises:
means for emitting a yellow light from the light source if a component is not interconnected with an interface corresponding to the luminescent icon;
means for emitting a green light from the light source if the component is interconnected with the interface corresponding to the luminescent icon and the interface is operating properly; and
means for emitting a red light from the light source if the component is interconnected with the interface corresponding to the luminescent icon and the interface is not operating properly.

70. An apparatus capable of displaying a luminescent icon, comprising:
means for emitting light from a light source;
means for masking a portion of the light to prevent the masked portion from propagating, wherein an unmasked portion of the light corresponds to a shape of the luminescent icon.

71. An apparatus, according to claim 70, wherein the means for emitting the light from the light source further comprises means for emitting the light from the light source if a predetermined condition exists.

72. An apparatus, according to claim 71, wherein the means for emitting the light from the light source further comprises means for emitting the light from the light source having a color corresponding to a predetermined condition.

73. An apparatus, according to claim 70, wherein the means for emitting the light from the light source further comprises:
means for emitting a yellow light from the light source if a component is not interconnected with an interface corresponding to the luminescent icon;
means for emitting a green light from the light source if the component is interconnected with the interface corresponding to the luminescent icon and the interface is operating properly; and
means for emitting a red light from the light source if the component is interconnected with the interface corresponding to the luminescent icon and the interface is not operating properly.
